(19) United States
(12) Patent Application Publication
(10) Pub. No.: US 2025/0214006 A1
(43) Pub. Date: Jul. 3, 2025

(54) FILTER CAKE SONICATION

(71) Applicant: BASF Corporation, Florham Park, NJ (US)

(72) Inventors: Tinoush Dinn, Beachwood, OH (US); Robert Prunchak, Beachwood, OH (US)

(21) Appl. No.: 18/851,230

(22) PCT Filed: Nov. 20, 2023
(86) PCT No.: PCT/US2023/080518

§ 371 Date: Sep. 26, 2024

Related U.S. Application Data
(60) Provisional application No. 63/426,906, filed on Nov. 21, 2022.

(51) Int. Cl. B01D 29/76; B01D 29/78; B01D 29/82; B01D 37/00

(52) U.S. Cl. CPC B01D 29/76; B01D 29/78; B01D 29/82; B01D 37/00

(57) ABSTRACT

Described herein is a method for filtration of a solid-liquid composition. The method may include passing the solid-liquid composition through a filter to form a filter cake on the filter and sonicating the filter cake. A filtration system is also provided for filtering a solid-liquid composition. The filtration system includes a filtration device and a sonication device.

### CROSS REFERENCE TO RELATED APPLICATION(S)

The present application claims priority to U.S. Provisional Patent Application No. 63/426,906 filed on Nov. 21, 2022, the contents of which are incorporated herein in its entirety.

### FIELD OF THE INVENTION

The present invention relates generally to a method and apparatus for the improved filtration of solid liquid composition resulting in filter cakes, cake wash and cake dewatering. Specifically, the method and apparatus utilize sonication to mitigate thixotropic nature of a filter cake and improve washing of the filter cake.

### BACKGROUND OF THE INVENTION

During the manufacturing process, filtration is an important step to remove any impurities or unwanted particles from a product. Filtration of the product is generally performed in multiple steps, including, but not limited to, filtering the product over a filter to form a filter cake and then washing the filter cake using a solution. Washing of the filter cake removes any impurities or unwanted particles from the product.

After the filter cake is washed, a gas is passed over the filter cake to remove some of the moisture content. This stage is often referred to dewatering or deliquoring. Thus, the two main steps of filtration are a (1) washing step and (2) a dewatering step. Removing impurities and removing moisture may be particularly challenging for some products based on the surface chemistry, bond between impurities-particles or formation of the filter cake.

This may result in a long wash time, and/or high consumption of the wash solution, which leads to a longer cycle time and generation of large amount of wastewater. This may also result in a long dewatering time and high moisture content in the final filter cake. If the moisture content is too high, then it will cause overload in the downstream processes and increase their energy consumption (e.g., in drying).

For example, a thixotropic filter cake may consume high wash liquor and require a longer wash and dewatering time. A thixotropic filter cake is shear thinning, meaning that if force is applied to the cake, it will turn into a liquid. If there is too much moisture in the thixotropic cake, it will be very difficult to process downstream.

To address these issues, chemical modifications have been tried but are often not successful. Chemical modifications may be undesirable because the chemicals may appear in the final product, impacting the quality of the product. Therefore, there is a need for a physical modification of the filter to address this.

### SUMMARY OF THE INVENTION

It has been found that using sonication in combination with the filtration, washing and dewatering step improves the overall filtration process.

The present invention is directed to a method for filtration of a solid-liquid composition. The method includes: providing a filter; passing the solid-liquid composition through the filter to form a filter cake on the filter; and sonicating the filter cake, the solid-liquid composition, or a combination thereof on the filter.

In some embodiments, the method for filtration may further include washing the filter cake with a wash liquor before performing the sonicating. In some embodiments, the sonicating of the filter cake and the washing of the filter cake may be performed at the same time. In some embodiments, the method may further include deliquoring the filter cake with a gas. In some embodiments, the method may further include mechanically squeezing the filter cake.

In some embodiments of the method, the washing of the filter cake may include ion removal, ion exchange, or modified surface functionality.

In some embodiments of the method, the sonicating may be performed using a sonication device. In some embodiments, the sonication device may include an audible device, an ultrasound device, a sound generator, an amplifier, a transducer device, or a combination thereof. In other embodiments, the sonication device may include an infrasound device. In some embodiments, the audible device may include a device that uses a frequency of less than or equal to about 20 kHz. In some embodiments, the ultrasound device may include a device that uses a frequency of about 20 kHz or greater than about 20 kHz. In some embodiments, the infrasound device may include a device that uses a frequency of less than about 20 Hz.

In some embodiments of the method, the filter cake may be sonicated at a frequency of about 20 Hz to about 1 GHz, about 5 kHz to about 800 kHz, about 20 kHz to about 750 kHz, about 50 kHz to about 500 kHz, about 75 kHz to about 250 kHz, or about 100 kHz to about 175 kHz. In some embodiments, the filter cake may be sonicated at a frequency of less than about 20 Hz.

In some embodiments, the sonicating may include sweeping frequencies for a time. In some embodiments, the sonication device may be at a distance of about 1 mm to about 20 cm to a surface of the filter cake. In some embodiments, the sonication device may be at a distance of about 1 mm to about 20 cm to the filter.

In some embodiments, the filter cake may be sonicated for about 1 second to about 36 hours, about 30 seconds to about 30 hours, about 1 minute to about 24 hours, about 5 minutes to about 18 hours, about 10 minutes to about 12 hours, about 20 minutes to about 10 hours, about 30 minutes to about 8 hours, about 40 minutes to about 6 hours, about 50 minutes to about 4 hours, or about 1 hour to about 2 hours, either intermittently or continuously. In some embodiments, the filter cake may be sonicated at a power of about 0.01 W/cm² of the filer area to about 5 kW/cm² of the filter area, about 0.1 W/cm² of the filter area to about 2.5 kW/cm² of the filter area, about 1 W/cm² of the filter area to about 1 kW/cm² of the filter area, about 5 W/cm² of the filter area to about 500 W/cm² of the filter area, about 15 W/cm² of the filter area to about 250 W/cm² of the filter area, or about 25 W/cm² of the filter area to about 100 W/cm² of the filter area. In another embodiment, the filter cake may be sonicated at a power of about 0.01 W/cm³ of filter cake volume to about 15 kW/cm³ of filter cake volume, about 0.1 W/cm³ of filter cake volume to about 10 kW/cm³ of filter cake volume, about 1 W/cm³ of filter cake volume to about 5 kW/cm³ of filter cake volume, about 5 W/cm³ of filter cake volume to about 2.5 kW/cm³ of filter cake volume, about 10 W/cm³ of filter cake volume to about 1 kW/cm³ of filter cake volume, about 50 W/cm³ of filter cake volume to about 500 W/cm³ of filter cake volume, or about 100 W/cm³ of filter cake volume to about 250 W/cm³ of filter cake volume.

In some embodiments of the method, sonicating the filter cake may be performed by having the sonication device in direct contact or indirect contact with the filter. In some embodiments, sonicating the filter may be performed by having the sonication device protrude into the filter cake. In some embodiments, the filtration may be performed under pressure or vacuum.

In some embodiments, the passing may be performed may be performed under gravity, the washing may be performed under gravity, and/or the deliquoring may be performed under gravity.

In some embodiments, cake density of the filter cake may be increased when compared to a non-sonicated filter cake. In some embodiments, uniformity of the filter cake may be increased when compared to a non-sonicated filter cake.

In another embodiment of the present invention, a filtration system for filtering a solid-liquid composition is provided. The filtration system for filtering a solid-liquid composition may include: a filtration device; and a sonication device, wherein the sonication device is configured to contact or protrude into a filter cake.

In some embodiments of the filtration system, the sonication device may be either in direct or indirect contact with the filter cake.

In some embodiments, the filtration device may include a housing and a filter. In some embodiments, the filter may include a vacuum filter, a belt filter a drum filter, a vacuum drum filter, a suction filter, a planar rotary filter, a filter press, a membrane filter press, or a pressure filter.

In some embodiments, the filter may include a device that is configured to operate under gravity, wherein the device may include a sieve, a mesh, a belt filter, or a belt press.

In some embodiments, the sonication device may include an audible sound device, ultrasound device, a sound transmission device, a sound generation device, an amplifier device, or a transducer device. In some embodiments, the sonication device may include an infrasound device.

In some embodiments of the filtration system, the solid-liquid composition may include a slurry, a filter cake or a thixotropic slurry. In some embodiments, the thixotropic slurry may have a moisture content of about 35 wt % to about 80 wt %, about 45 wt % to about 75 wt %, about 50 wt % to about 70 wt %, or about 55 wt % to about 65 wt % based on the thixotropic slurry composition. In another embodiment, the slurry may have a solid content of about 0.5 wt % to about 65 wt %, about 2.5 wt % to about 60 wt %, about 5 wt % to about 55 wt %, about 10 wt % to about 50 wt %, about 15 wt % to about 45 wt %, about 20 wt % to about 40 wt %, or about 25 wt % to about 35 wt % based on the weight of the slurry composition.

In some embodiments, the solid-liquid composition may include a particle having a mean particle size of about 3 μm to about 1000 μm.

In yet another embodiment of the present invention, a method for filtering a solid-liquid composition may include passing the solid-liquid composition through a filter to form a filter cake; washing the filter cake with a wash liquor; and sonicating the filter cake using a sonication device.

In some embodiments, the wash liquor may include deionized water, an ion exchange liquor, or an ion removal liquor.

In some embodiments of the method, the washing and sonicating may be performed intermittently or continuously. In some embodiments, sonicating the filter cake may be performed during the passing of the solid-liquid composition and before the washing of the filter cake. In another embodiment, the washing and sonicating may be performed sequentially as a cycle.

In some embodiments, the method may further include deliquoring the filter cake using a gas. In some embodiments, the gas may be air or nitrogen (N₂).

In some embodiments of the method, the cycle may be repeated about 2 times, about 3 times, about 4 times, about 5 times, 6 times, about 7 times, about 8 times, about 9 times, or about 10 times.

In some embodiments of the method, the washing may be performed for a time period. In some embodiments, the time period may be about 1 minute to about 36 hours about 15 minutes to about 30 hours, about 30 minutes to about 24 hours, about 45 minutes to about 18 hours, about 1 hour to about 12 hours, about 2 hours to about 10 hours, about 3 hours to about 8 hours, or about 4 hours to about 6 hours.

In some embodiments of the method, the sonicating may be applied at an interval during the time period of washing. In some embodiments, the interval may be about 5 minutes, about 10 minutes, about 15 minutes, about 20 minutes, about 30 minutes, about 45 minutes, about 1 hour, about 2 hours, about 3 hours, or about 4 hours.

In some embodiments, the interval may be applied about 1 time, about 2 times, about 3 times, about 4 times or about 5 times during the time period of washing.

### BRIEF DESCRIPTION OF THE DRAWINGS

The disclosure described herein is illustrated by way of example and not by way of limitation in the accompany figures.

FIG. 1 is a schematic of a filtration system according to an embodiment of the present disclosure.

FIG. 2 is a schematic of a filtration system according to another embodiment of the present disclosure.

FIG. 3 is a schematic of a filtration system according to a third embodiment of the present disclosure.

FIG. 4 is a schematic of a filtration system according to fourth embodiment of the present disclosure.

### DETAILED DESCRIPTION OF THE INVENTION

The present invention advances the state of the art by developing a method for filtering a solid-liquid composition using sonication on a filter cake. The method of the present disclosure may reduce filtration cycle time and increase production rates. In another example, enhancing the filtration of a solid-liquid composition, such as a slurry, and wash of filter cakes can result in improved cycle time and throughput. In some embodiments, these two aspects may be improved by adding reagents such as flocculants. In other embodiments, no reagent may be added because the filter cake is the product and physical intervention may be desirable instead of a chemical modification.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein. “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The articles “a”, “an”, and “the” are used herein to refer to one or to more than one (i.e., to at least one) of the grammatical object of the article. By way of an example, “a filter” means one filter or more than one filter.

As used herein, the term “solid-liquid composition” will be understood by persons of ordinary skill in the art as meaning a slurry, wherein the slurry includes solid particles that are suspended in a liquid, such as water, an organic solvent, and/or oil.

Unless explicitly stated otherwise, all percentages stated in connection with the compositions herein described refer to a weight percent, respectively based on the mixture or composition in question.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

In the filtration of a solid-liquid mixture of substances using a filter, an on-growing layer of the separated solid builds on the filter with time, which is herein called the filter cake. The filter cake may cause an overall pressure loss between the application side and the filtrate side of the filter. The filter cake has a continuous structure which may lead to a flow resistance (pressure loss) that increases with time, so that less and less liquid (solvent) passes through the filter cake. A measure of the flow resistance is known as filter cake resistance. In some instances, the pressure on the application side may be increased to keep the liquid flow constant or to increase liquid flow with time.

In some embodiments, the filter cake may be formed using a filter having pore openings larger than the particle diameters of the particles to be separated off. The filter cake may include particles to be separated off, which are present in an approximately close packing, depending on their particle diameter. The pores of the filter cake may be smaller than the particles to be separated.

In one embodiment of the present disclosure, a method for filtering a solid-liquid composition is provided. The method may be especially useful for solid-liquid compositions having a high moisture content, or those that form a thixotropic filter cake. The method may further improve washing the filter cake, and/or the wash flowrate through the filter cake. The method for filtering the solid-liquid composition may include providing a filter, passing the solid-liquid composition through the filter to form a filter cake and sonicating the filter cake, the solid-liquid composition, or a combination thereof on the filter. In some embodiments, the sonicating of the filter cake may occur while the solid-liquid composition is passing through the filter to form a filter cake. That is, the sonicating of the filter cake may occur concurrently while the solid-liquid composition passes through the filter to form a filter cake.

In some embodiments, the solid-liquid composition may include a catalyst as the solid and a low conductivity water as the liquid. In some embodiments, the low conductivity water may be less than 1000 μS/cm, deionized water, distilled water, or tap water.

In an embodiment, the method may further include washing the filter cake with a wash liquor before sonicating the filter. The wash liquor may include a deionized water, ion removal liquor, ion exchange liquor, or a liquor to modify surface functionality. Examples of the wash liquor include but are not limited to about 0.1 to 100% sulfuric acid solution, about 0.1 to 100% acetic acid solution, about 0.1 to 60% ammonium nitrate solution, about 0.1 to 60% ammonium acetate solution, about 0.1 to 10% copper acetate monohydrate solution, or about 0.1 to 20% iron sulfate heptahydrate solution. Concentrations may be increased by increasing the temperature of the liquor. In some embodiments, the method may further include dewatering or deliquoring the filter cake using a gas. The gas may be air or nitrogen (N₂) with pressures from 1 to 225 psig and flowrate from 1 to 400 scfm.

In an embodiment, the sonicating may be performed using a sonication device. In some embodiments, the sonication device may include an infrasound device, an audible device, an ultrasound device, a sound generator, an amplifier, a transducer device, or a combination thereof. In some embodiments, the audible device includes a device that uses a frequency of less than or equal to about 20 kHz. In another embodiment, the ultrasound device includes a device that uses a frequency of about 20 kHz or greater than about 20 kHz. In some embodiments, the infrasound device includes a device that uses a frequency below 20 Hz. In some embodiments, the sonication device may include a transducer, sound generator, amplifier, or combination thereof. In some embodiments, the transducer may be a non-contact or air-borne transducer. In other embodiments, the sonication device may be used in combination with a transducer plate or a vibrating plate. The transducer plate or vibrating plate may be a titanium plate, aluminum plate or a combination thereof. In some embodiments, the transducer plate or vibrating plate may be rectangular or circular. It is understood that any other material and shape that may efficiently distribute sound energy within the plate and emit sound waves & energy can be used

In an embodiment of the method, the filter cake may be sonicated at a frequency of about 20 Hz to about 1 GHz, 5 kHz to about 800 kHz, about 20 kHz to about 750 kHz, about 50 kHz to about 500 kHz, about 75 kHz to about 250 kHz, or about 100 kHz to about 175 kHz, or any value, range or sub-range therein. In another embodiment, the filter cake may be sonicated at a frequency of about 1 Hz to about 1 GHz, or any value or sub-range therein.

In some embodiments, the filter cake may be sonicated by sweeping frequencies. In some embodiments, the sweeping frequencies may be from about 1 Hz to about 120 Hz. In other embodiments, the sweeping may be from about 1 Hz to about 200 Hz, about 10 Hz to about 300 Hz, about 100 Hz to about 500 Hz, about 250 Hz to about 750 Hz, or any suitable range to sweep frequency.

In some embodiments, the filter cake may be sonicated at a range of frequencies, or a combination of multiple ranges in a filtration cycle. For example, the range of frequency may be about 1 Hz to about 1000 Hz. In some embodiments, the power of the sonication may be varied depending on each stage of the filtration cycle. In certain embodiments, the energy and/or power received by the filter cake may depend on a variety of factors, such as distance from the sonication device, shape of the sonication device and/or filter. For example, during filtration, the filter cake may sonicated with a frequency between about 600 Hz to 800 Hz at a power of about 150 W to about 200 W, where the filter cake would receive an estimated power of about 0.1 W/cm² to about 0.6 W/cm². In another example, during cake wash and deliquoring it may be sonicated with a frequency between about 1 Hz to about 120 Hz at a power of about 100 W, where the filter cake receives an estimated power of about 0.1 W/cm² to about 0.3 W/cm².

In an embodiment of the method, the filter cake may be sonicated for about 1 second to about 36 hours, about 30 seconds to about 30 hours, about 1 minute to about 24 hours, about 5 minutes to about 18 hours, about 10 minutes to about 12 hours, about 20 minutes to about 10 hours, about 30 minutes to about 8 hours, about 40 minutes to about 6 hours, about 50 minutes to about 4 hours, or about 1 hour to about 2 hours, either intermittently or continuously.

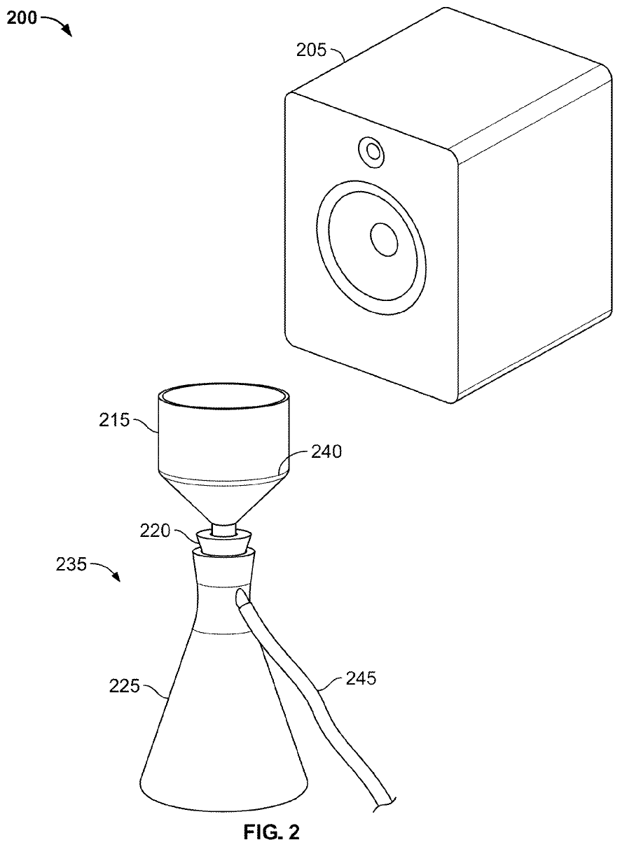

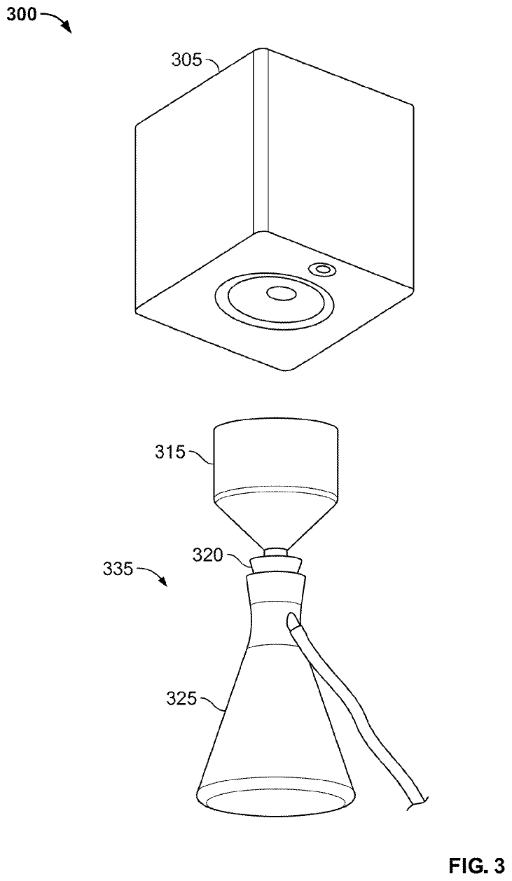

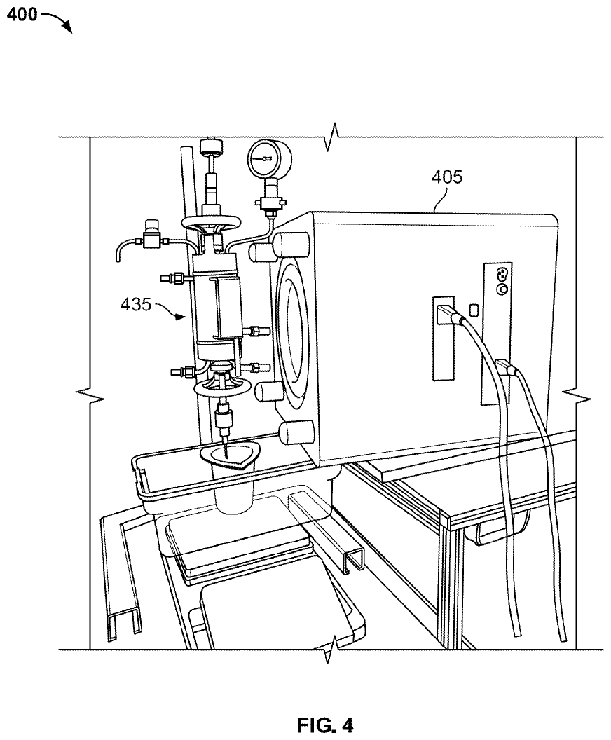

In an embodiment of the method, the filter cake may be sonicated at a power of about 0.01 W/cm² of the filter area to about 5 kW/cm² of the filter area, about 0.1 W/cm² of the filter area to about 2.5 kW/cm² of the filter area, about 1 W/cm² of the filter area to about 1 kW/cm² of the filter area, about 5 W/cm² of the filter area to about 500 W/cm² of the filter area, about 15 W/cm² of the filter area to about 250 W/cm² of the filter area, or about 25 W/cm² of the filter area to about 100 W/cm² of the filter area. In other embodiments, the filter cake may be sonicated at a power of about 0.001 W/cm² of the filter area to about 25 kW/cm² or any value or sub-range herein. In some embodiments, the rate of power received by the filter cake may vary between about 0.001% to about 100% depending on the distance of the source to the filter cake, filter setup, material of construction of filter setup, angle of sonication device relative to cake surface and whether the filter is open (e.g. FIGS. 2 and 3) or enclosed (e.g. FIG. 4).

In another embodiment of the method, the filter cake may be sonicated at a power of about 0.01 W/cm³ of filter cake volume to about 15 kW/cm³ of filter cake volume, about 0.1 W/cm³ of filter cake volume to about 10 kW/cm³ of filter cake volume, about 1 W/cm³ of filter cake volume to about 5 kW/cm³ of filter cake volume, about 5 W/cm³ of filter cake volume to about 2.5 kW/cm³ of filter cake volume, about 10 W/cm³ of filter cake volume to about 1 kW/cm³ of filter cake volume, about 50 W/cm³ of filter cake volume to about 500 W/cm³ of filter cake volume, or about 100 W/cm³ of filter cake volume to about 250 W/cm³ of filter cake volume.

In an embodiment of the method, the sonicating of the filter cake may be performed by having the sonication device in direct contact or indirect contact with the filter. In another embodiment, the sonicating of the filter cake may be performed by having the sonication device protrude into the filter cake. In some embodiments, when the sonication device is performed by indirect contact with the filter, it may be angled toward the surface of the filter cake. In another embodiment, the sonication device may be perpendicular to the surface of the filter cake. In other embodiments, the sonication device may be at a distance from the filter and/or filter cake of about 1 mm to about 10 cm, about 1 mm to about 20 cm, about 5 mm to about 20 cm, about 5 mm to about 10 cm, 10 mm to about 5 cm, or any range, value or sub-range herein.

In another embodiment of the present disclosure, a filtration system for filtering a solid-liquid composition is provided. The filtration system may include a filtration device and a sonication device, wherein the sonication device is configured to contact or protrude into a filter cake. In some embodiments, the sonication device is either in direct or indirect contact with the filter cake.

In an embodiment of the filtration system, the filtration device may include a housing and a filter. In some embodiments, the filter may include a vacuum filter, a belt filter, a drum filter, a vacuum drum filter, a suction filter, a nutsche filter, a planar rotary filter, a filter press or a membrane or diaphragm filter press (membrane plates can squeeze the cake), or a pressure filter.

In some embodiments of the filtration system, the sonication device may include an audible or an ultrasound device, a sound transmission device, a sound generation device, an amplifier device, a transducer device, an infrasound device, or a combination thereof.

In some embodiments, the solid-liquid composition may include a filter cake, a slurry or a thixotropic slurry. In some embodiments, the thixotropic slurry may have a moisture content of about 35 wt % to about 80 wt %, about 45 wt % to about 75 wt %, about 50 wt % to about 70 wt %, or about 55 wt % to about 65 wt % based on the thixotropic slurry composition. In some embodiments, the slurry may have a solid content of about 0.5 wt % to about 65 wt %, about 2.5 wt % to about 60 wt %, about 5 wt % to about 55 wt %, about 10 wt % to about 50 wt %, about 15 w t % to about 45 wt %, about 20 wt % to about 40 wt %, or about 25 wt % to about 35 wt % based on the weight of the slurry composition.

In another embodiment of the present disclosure, a method for filtering a solid-liquid composition is provided. The method may include passing the solid-liquid composition through a filter to form a filter cake; washing the filter cake with a wash liquor; and sonicating the filter cake using a sonication device. In some embodiments, the wash liquor may include deionized water, an ion exchange liquor or an ion removal liquor. Examples of the wash liquor may include, but are not limited to about 0.1 to 100% sulfuric acid solution, about 0.1 to 100% acetic acid solution, about 0.1 to 60% ammonium nitrate solution, about 0.1 to 60% ammonium acetate solution, about 0.1 to 10% copper acetate monohydrate solution, about 0.1 to 20% iron sulfate heptahydrate solution.

In an embodiment of the method, the washing and sonicating may be performed intermittently or continuously. In another embodiment of the method, the washing and sonicating may be performed sequentially as a cycle. In some embodiments, the cycle may be repeated about 2 times, about 3 times, about 4 times, about 5 times, about 6 times, about 7 times, about 8 times, about 9 times or about 10 times.

In some embodiments, the method may further include deliquoring the filter cake using a gas. In some embodiments, the gas may be air or nitrogen (N₂).

In some embodiments, the washing may be performed for a time period. In some embodiments, the time period may be about 5 minutes to about 36 hours about 15 minutes to about 30 hours, about 30 minutes to about 24 hours, about 45 minutes to about 18 hours, about 1 hour to about 12 hours, about 2 hours to about 10 hours, about 3 hours to about 8 hours, or about 4 hours to about 6 hours.

In some embodiments of the method, the sonicating may be applied at an interval during the time period of washing. In some embodiments, the interval may be about 5 minutes, about 10 minutes, about 15 minutes, about 20 minutes, about 30 minutes, about 45 minutes, about 1 hour, about 2 hours, about 3 hours, or about 4 hours, or greater. The interval may also be applied about 1 time, about 2 times, about 3 times, about 4 times or about 5 times during the time period of washing.

It has been found that using sonication improves the filtration time of the solid-liquid composition. For example, performing sonication using a sweeping frequency of about 600 Hz to about 800 Hz may reduce filtration time. It has also been found that using sonication at a single frequency or a sweeping frequency improves cake wash. For example, sonication improves the removal of unwanted substances during washing of the filter cake and can reduce the filter cake moisture content or reduce wash time of the filter cake.

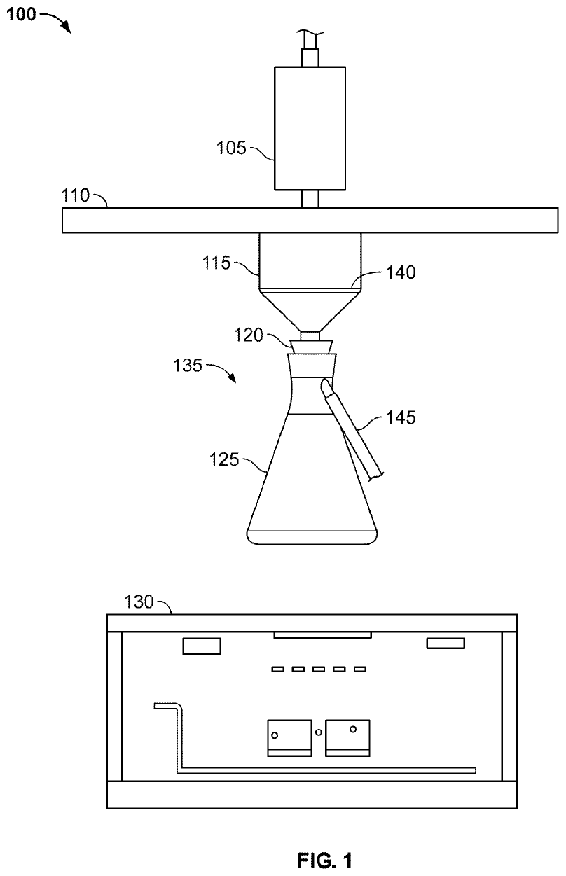

Referring now to the Figures, FIG. 1 refers to schematic of a filtration system 100 according to an embodiment of the present disclosure. The filtration system 100 includes a sonication device 105 and a vibration plate 110 that may be in contact with a filter device 135 or may not be in contact having a distance of about 0.0001 mm to 20 cm or more to the filter device 135. The vibrating plate 110 may a titanium plate, aluminum plate or other materials suitable to distribute sound energy or a combination thereof. The filter device 135 may be a vacuum filter. As shown herein, the filter device 135 may include a Buchner funnel 115 or any other suitable filtration devices for filtering a solid-liquid composition. As can be seen in FIG. 1, the Buchner funnel 115 incudes a filter 140. The filter 140 may include a porous plate and/or filter paper. The porous paper may be a plate with holes in it, where the holes may be a variety of sizes depending on the solid-liquid composition. The filter device 135 further includes a rubber bung 120 that connects the Buchner funnel 115 to the Buchner flask 125. The Buchner flask 125 includes a rubber tubing 145 that may attach to a vacuum pump (not pictured). In some embodiments, filtration may occur without applying vacuum. For example, the solid and liquid may be separated with gravity and assisted with sonication from the sonication device 105. Attaching the Buchner flask 125 to a vacuum pump creates partial or complete vacuum, for example 0.001 to 29.92 in Hg of the filtration system 100. The sound generator 130 is attached to the sonication device 105 to supply the desired power. In some embodiments, the sonication device 105 may be an audible device, an ultrasound device, a sound generator, an amplifier, a transducer device, infrasound device or a combination thereof. For example, in the examples, an ultrasound device was used as the sonication device 105. In some embodiments, the sound generator may provide a power of up to about 225 W to the sonication device 105. Depending on the desired conditions of the filtration the power may vary, i.e. the power may be decreased to a lower power or increased to higher power, such as 1000 W.

FIG. 2 refers to schematic of a filtration system 200 according to another embodiment of the present disclosure. The filtration system 200 includes a sonication device 205 that is not in contact with a filter device 235, but rather is off to the side of the filter device 235. The filter device 235 may be a vacuum filter. The filter device 235 may include a Buchner funnel 215 or any other suitable filtration devices for filtering a solid-liquid composition. As can be seen in FIG. 2, the Buchner funnel 215 incudes a filter 240. The filter 240 may include a porous plate and/or filter paper. The porous paper may be a plate with holes in it, where the holes may be a variety of sizes depending on the solid-liquid composition. The filter device 235 further includes a rubber bung 220 that connects the Buchner funnel 215 to the Buchner flask 225. The Buchner flask 225 includes a rubber tubing 245 that attaches to a vacuum pump (not pictured). Attaching the Buchner flask 225 to a vacuum pump creates partial or complete vacuum for the filtration system 200. In some embodiments, the filtration system 200 may be used without applying vacuum. For example, the solid and liquid may be separated with gravity and assisted with the sonication device 205. The sonication device 205 may be connected to a sound generator (not pictured) to supply the desired power and/or frequencies. In some embodiments, the sonication device 205 may be an audible device, an ultrasound device, a sound generator, an amplifier, a transducer device, infrasound device or a combination thereof. For example, in the examples, an infrasound device was used as the sonication device 205.

FIG. 3 refers to schematic of a filtration system 300 according to a third embodiment of the present disclosure. The filtration system 300 includes a sonication device 305 that is not in contact with a filter device 335, but rather is above the filter device 335. In some embodiments, the sonication device 305 may be angled above the filter at any possible angel to transfer the frequency/wave from the sonication device to the Buchner funnel. The filter device 335 is similar to the filter devices of FIGS. 1 and 2. The filter device 235 includes a Buchner funnel 315, a rubber bung 320 that connects the Buchner funnel 315 to the Buchner flask 325. The Buchner flask 225 includes a rubber tubing that attaches to a vacuum pump (not pictured). Attaching the Buchner flask 325 to a vacuum pump creates partial or complete vacuum of the filtration system 300. In some embodiments, the filtration system 200 may be used without applying vacuum. For example, the solid and liquid may be separated with gravity and assisted with the sonication device 305. The sonication device 305 may be connected to a sound generator (not pictured) to supply the desired power and/or frequencies. In some embodiments, the sonication device 305 may be an audible device, an ultrasound device, a sound generator, an amplifier, a transducer device, infrasound device or a combination thereof. For example, in the examples, an audible device was used as the sonication device 305.

FIG. 4 refers to a schematic of a filtration system 400 according to a fourth embodiment of the present disclosure. The filtration system 400 includes a sonication device 405 that is not in contact with a filter device 435 but is placed such that the sound reaches the filter device 435 on the side of the device 435. The filter device 435 may be a pressure filter, such as a Nutsche filter, where the filtration occurs under pressure. For example, the pressure may be at about 0.1 barg to about 10 barg. The filter device 435 may further include a perforated plate, filter paper, cloth, or a combination thereof as described with reference to FIG. 1.

### EXAMPLES

The following examples are intended to be illustrative and are not meant in any way to limit the scope of the disclosure.

Various studies were conducted using an ultrasound device in combination with a variety of filters.

### Sonication Using an Ultrasound Device

In a first study, an ultrasound device was used as the sonication device. The ultrasound device was from Pusonics RD and was used in combination with a vacuum filter. The vacuum filter of the present study was a Buchner filter as can be seen in FIG. 1. The ultrasound device used in the study includes a transducer having a frequency of 21 kHz, and a sound generator and amplifier having a power of 225 W. In the filtration system of the present study, the transducer was connected to a titanium plate, which corresponds to a transducer plate or vibrating plate. The titanium plate had the following dimensions: 43.4 cm long, 23.1 cm wide, and 2.5 cm thickness. The titanium plate was used to generate non-contact or air borne waves.

The test material of the present study included a catalyst powder with a base of sodium silicate and clay. The catalyst powder had a mean particle size of about 72 μm. As discussed herein, the catalyst powder will be referred to as Sample 1. The test material of Sample 1 was mixed with low conductivity water to form a slurry. The slurry was prepared to be a 40 wt % slurry using about 52 g of Sample 1 measured on a dry basis with about 78 g low conductivity water and was mixed for about 5 minutes on a magnetic stirrer.

The slurry was then filtered under 15 inHg vacuum until a cake surface appeared, i.e. forming a filter cake. In this study, formation of a filter cake was considered the end of filtration. To perform the filtration, a vacuum pump was used to create the 15 inHg vacuum. A plastic Buchner funnel having a diameter of about 9.1 cm and Whatman filter paper 42 having a diameter of 9 cm and pore size of approximately 2.5 μm were used when filtering the slurry. After forming the filter cake, about 25 grams of low conductivity water was introduced on top of the filter cake to wash the cake. This was then followed with a suction of air through the cake by vacuum to achieve cake dewatering for 1 minute. The wash filtrate was then collected separately, and its conductivity was measured to assess the removal of salts or impurities from the filter cake. Various tests were run using this setup and following the described parameters, where the power applied to the filter system was varied along with its distance from the vibrating plate.

In the study, a comparative test without sonification was performed three times (base case tests 1-3, Table 1). The process and material properties obtained from cake sonication tests were compared with the averaged values for the base cases which is shown in row “Averaged of 1, 2, and 3”. The results in Table 1 illustrate that the sonication of the filter cake shortened the cake wash time and/or increased wash filtrate flow rate significantly without compromising salt or impurity removal because the conductivity of wash filtrate remains almost the same when compared with the averaged base case.

TABLE 1
Filtration and wash experiments on Slurries with Sample 1 as base case and sonication with 21
kHz transducer. The row “Averaged” contains averaged data of base cases, i.e. tests #1, 2, 3

| | | | | | | | | | | Power |
|---|---|---|---|---|---|---|---|---|---|---|
| | | Cake | | Wash | Wash time | | Distance | | | received |
| | Cake | wash | Wet | filtrate | diff to | Input | to cake | | | by the |
| | height | time | Cake | conductivity | base case | Power | surface | | View | sample |
| Test No | (mm) | (s) | (g) | (μS/cm) | (%) | (W) | (mm) | | factor | (W/cm²) |
| 1 | 8 | 92 | 83 | 32100 | — | — | — | | — | — |
| 2 | 8 | 80 | 80 | 30600 | — | — | — | | — | — |
| 3 | 8 | 82 | 80 | 32700 | — | — | — | | — | — |
| Averaged | 8 | 85 | 81 | 31800 | — | — | — | | — | — |
| of 1, 2, 3 | | | | | | | | | | |
| 4 | 9 | 67 | 83 | 31300 | −21% | 115 | 42 | mm | 0.060 | 0.11 |
| 5 | 8 | 75 | 85 | 32900 | −11% | 200 | 42 | mm | 0.060 | 0.19 |
| 6 | 9 | 44 | 83 | 31600 | −48% | 120 | 15 | mm* | 0.064 | 0.12 |
| 7 | 9 | 47 | 83 | 32600 | −44% | 120 | 15 | mm* | 0.064 | 0.12 |
| 8 | 9 | 50 | 80 | 32700 | −41% | 120 | 33 | mm* | 0.062 | 0.11 |
| 9 | 9 | 51 | 82 | 32040 | −40% | 160 | 15 | mm* | 0.064 | 0.16 |

*The distance of the vibrating plate to the surface of added wash water in the buchner funnel kept constant during the wash at the distance showed in the table. During the wash, the water level reduces as the water passes through the cake, and the filter device distance to the vibrating plate progressively reduced to maintain the distance between the plate and the liquid level.

It was found that the input power to the transducer and the distance of the filter cake, filter medium and the liquid inside the Buchner funnel from the vibrating plate had an impact on received power by the sample and wash efficiency. The air-borne wave was deemed to be sinusoidal. It was also found that the average sound pressure near the vibrating plate (less than a few centimeters) was higher. The average sound pressure decays as the distance between the sample and the vibrating plate increases. The power received by the surface of the liquid or cake within the Buchner funnel (W/cm²) was roughly estimated using a so-called view factor available as described in Journal of Thermophysics and Heat Transfer Vol. 21, No. 1, January-March 2007, “View Factors between Disk/Rectangle and Rectangle in Parallel and Perpendicular Planes”. The view factor is the ratio of the rate (input power) at which the rectangular vibrating plate emits energy which directly is received by sample surface within the Buchner funnel.

In tests 4 and 5, the distance of the vibrating plate to the cake surface was kept constant, and the applied power was varied. The power received by the sample surface was higher in test 5 at 200 W, but the wash time was longer than test 4 at 115 W input power. Without being bound by a theory, this is believed to be because higher sounds pressure generated by the vibrating plate at 200 W which can compress the top layer of the cake (or the layers underneath) resulting in higher cake density (cake weight on dry basis divided by cake volume) or rearrange the cake bed and particles, thus reducing the filtrate flowrate. Additionally, as the wash water passes through the cake, the wash water level in the Buchner funnel approaches the cake, and the distance between the liquid surface and the vibrating plate increases. Thus, the impact of cake sonication was reduced when compared with the tests where the distance between the wash liquid level and the vibrating plate was kept constant in tests 6, 7, 8 and 9. This is believed to be because the sound pressure decays as the distance to vibrating plate increases.

Test 7 was a repeat of test 6, which demonstrated that the results are reproducible. Additionally, the wash time was reduced by about 48% without impacting the impurity or salts removal. In test 8, the distance between the vibrating plate and the liquid level was increased to 33 mm and the impact of cake sonication on wash time reduced, when comparing wash time in test 8 with test 6. In test 9, the input power and the power received by the sample surface was increased, where the cake sonication impact was reduced when compared with test 6. From this, it confirmed that the relationship between power and distance between the sample surface and vibrating plate and wash time are not linear. It is also noted that the tests as described herein were all performed at room temperature.

### Sonication Using Infrasound and Audible Frequencies

An additional study was performed where the sonication device is used with infrasound frequencies and audible frequencies. In this study, three different solid samples were used. Sample 1 used the catalyst powder as described in the study with ultrasound frequency. Sample 2 included an aluminum oxide powder with a mean particle size of about 6 μm, and Sample 3 included a chabazite catalyst with a mean particle size of about 3 μm. The slurries prepared using Sample 2 and 3 formed thixotropic filter cakes when passed through the filtration system of the study. The sonication device used in this study can be seen in FIG. 3. Two low frequency transducers were used in the testing. In the first filtration system setup, a 70 W 5 inch transducer (Yamaha HS51) was used. In the second filtration system setup, a 200 W 10 inch transducer (JBL LSR310S) was used as the sonication device. The frequency for the study was generated on a laptop with a software, which was then sent to a mixer (Yamaha AG06MK2) to control the volume and gain, which was then sent to the transducers.

The effect of sonicating on the filtration time was studied using a vacuum filtration device as can be seen in FIG. 3. The results of this study can be seen in Table 2. A slurry using Sample 1 was prepared as described above and was filtered through the vacuum filter setup. The filter cake was sonicated with the 200 W 10 inch transducer and corresponds to tests 10 and 11 in Table 2. Test 10 was performed at 50% volume, where about 50% power was applied, i.e. 100 W, with a sweeping frequency of between 600 to 800 Hz every 10 seconds. During this test, a continuous sonication was used where the frequency ramped up from 600 to 800 Hz and then ramped down to 600 Hz in 10 seconds. The sonication was applied continuously during filtration and/or dewatering. Test 11 was performed at 100%, where about 100% power was applied, i.e. 200 W. During this test, the same sweeping frequency of between 600 to 800 Hz every 10 second was used.

A slurry was prepared using Sample 2, to form Sample 2a. Sample 2a was prepared by mixing 50 g of aluminum oxide powder with 75 g low conductivity water to make a 40 wt % slurry. Test 12 was run as the comparative example, i.e. base case vacuum filtration. Test 13 was performed at 50% volume (50% power, i.e. 100 W), with a sweeping frequency of between about 600 to about 800 Hz every 10 seconds.

The view factor was calculated based on two finite co-axial discs (speaker subwoofer and cake surface inside the buchner funnel) in parallel with different radii.

TABLE 2
Filtration experiments without cake wash using 10″ low
frequency transducer in audible range frequencies, vacuum setup).

| | | | | | | | Estimated |
|---|---|---|---|---|---|---|---|
| | | | | | | | Power |
| | | | Filtration | | Distance | | received |
| | | Cake | time diff to | Input | to cake | | by the |
| | Filtration | height | base case | Power | surface | View | sample |
| Test No | time (s) | (mm) | (%) | (W) | (mm) | factor | (W/cm²) |
| Sample 1 Base case | 79 | 8 | — | — | — | — | — |
| Averaged | | | | | | | |
| 10 (Sample 1) | 49 | 8 | −38% | 100 | 30 | 0.120 | 0.19 |
| 11 (Sample 1) | 62 | 9 | −21% | 200 | 30 | 0.120 | 0.37 |
| 12 (Sample 2a base case) | 805 | 9 | — | — | — | — | — |
| 13 (Sample 2a) | 652 | 9 | −19% | 100 | 30 | 0.186 | 0.22 |

As can be seen in Table 2, there was clear improvement in vacuum filtration time (Tests 10, 11 and 13) at both 50% and 100% power. In these tests, the distance between cake surface and the transducer screen was kept constant. Thus, the improvement was believed to be because sonicating the filter cake reduces the filter cake resistance and/or increases the cake uniformity (for example, uniform distribution of particle sizes in the cake) and/or facilitate the passage of the liquid through the pores of the filter cake forming. The higher power (test 11) had less impact when compared to the half power (test 10) in shortening of the filtration time. This is possibly because of compressing the filter cake and rearranging of the particles in the cake bed.

A similar study was conducted using a pressure filtration at 2 barg in combination with the sonication device (FIG. 4). The results of this study are shown in Table 3. A slurry using Sample 2 was prepared to form Sample 2b. Sample 2b was prepared by mixing 25 g aluminum oxide powder with 38 g of low conductivity water to make a 40 wt % slurry. A test was performed to filter Sample 2b without sonication as a base case, Test 14. Additional tests were performed under sonication with 75% volume (75% power, i.e. 150 W) in Test 15 and 100% volume (100% power, i.e. 200 W) in Test 16 with a sweeping frequency of between 600 to 800 Hz every 10 seconds. The nutsche filtration wall was made of stainless steel and may be considered as a barrier for sound waves. However, these tests show that the sound waves were still able to penetrate through the nusche wall and impact the filtration, and reduced the filtration time by 5% and 11% respectively in tests 15 and 16 when compared to the base case test 14.

TABLE 3
Filtration experiments without cake wash using 10″ low frequency
transducer in audible range frequencies, using nutsche filter.

| | | | | | | | Estimated |
|---|---|---|---|---|---|---|---|
| | | | | | | | Power |
| | | | Filtration | | Distance | | received |
| | | Cake | time diff to | Input | to cake | | by the |
| | Filtration | height | base case | Power | surface | View | sample |
| Test No | time (s) | (mm) | (%) | (W) | (mm) | factor | (W/cm²) |
| 14 (Sampel 2b base case) | 375 | 13 | — | — | — | — | — |
| 15 (sample 2b) | 355 | 13 | −5% | 150 | — | — | — |
| 16 (Sample 2b) | 335 | 13 | −11% | 200 | — | — | — |

Table 4 summarizes vacuum filtration and cake wash experiments on slurry Sample 1 and Sample 2a as described above. The sweeping frequency of the sonication device was varied amongst the samples. The wash time was compared with the base case averaged values shown in Table 1 and presented in the first row of Table 4. Tests 21 shows the base case for Sample 2a. As can be seen in Table 4, the sonication at various sweeping frequencies shows a reduction in wash time without affecting the impurity or salt removal.

TABLE 3
Vacuum Filtration and cake wash experiments on slurries using Sample 1 and sample 2a
using 5″ & 10″ low frequency transducer in infrasound and audible range frequencies

| | | | | | | | | | Estimated |
|---|---|---|---|---|---|---|---|---|---|
| | | | | | Wash | | | | Power |
| | | Cake | | | time | | Distance | | received |
| Test No | Cake | wash | Wet | Wash filtrate | diff to | Input | to cake | | by the |
| (sweeping | height | time | Cake | conductivity | base case | Power | surface | View | sample |
| frequency) | (mm) | (s) | (g) | (μS/cm) | (%) | (W) | (mm) | factor | (W/cm²) |
| Sample 1 - base | 8 | 85 | 81 | 31800 | — | — | — | — | — |
| case Averaged | | | | | | | | | |
| 17 - sample 1 | 9 | 51 | 79 | 31500 | −40% | 70 | 30 | 0.377 | 0.41 |
| (1-120 Hz, 10 s) | | | | | | | | | |
| 18 - sample 1 | 9 | 50 | 81 | 29700 | −41% | 70 | 30 | 0.377 | 0.41 |
| (1-120 Hz, 10 s) | | | | | | | | | |
| 19 - sample 1 | 8 | 68 | 77 | 31400 | −20% | 70 | 30 | 0.377 | 0.41 |
| (1-120 Hz, 5 s) | | | | | | | | | |
| 20 - sample 1 | 10 | 63 | 82 | 32300 | −26% | 70 | 30 | 0.377 | 0.41 |
| (80-120 Hz, 10 s) | | | | | | | | | |
| 21 - sample 2a | 9 | 1119 | 89 | 1120 | base | — | — | — | — |
| Base case | | | | | case | | | | |
| 22 - sample 2a | 9 | 998 | 89 | 1020 | −11% | 100* | 30 | 0.120 | 0.19 |
| (1-120 Hz, 10 s) | | | | | | | | | |
| 23 - sample 2a | 8 | 955 | 89 | 970 | −15% | 100* | 30 | 0.120 | 0.19 |
| (5-15 Hz, 5 s) | | | | | | | | | |

*10″ low frequency transducer

Table 5 summarizes the vacuum filtration and cake wash experiments on slurries prepared using Sample 3 using the vacuum filtration setup as described above and shown in FIG. 3. The slurry with Sample 3 was prepared by mixing 30 g of chabazite powder and 70 g low conductivity water. The slurry was filtered, and then the cake was washed in two steps: first with 20 g of 1.2 wt % ammonium acetate solution, and second with 20 g of deionized water, followed by cake dewatering. Test 24 was the base case test. Test 25 was performed using cake sonication with 50% volume (50% power, 100 W) and sweeping frequency of 600 to 800 Hz for 10 seconds during both washes and sweeping 1 to 120 Hz for 10 seconds during cake dewatering. In Test 26, cake sonication was performed during filtration and both washes with 50% volume (50% power, 100 W), and sweeping frequency of 600 Hz to 800 Hz for 10 s, then sweeping at 1 to 120 Hz for 10 second during cake dewatering. Both Tests 25 and 26 showed significant improvement in wash times. The sonication also reduced the moisture content of the final filter cake by 1.8 and 2.5% in tests 25 and 26, respectively, which can correspond to the thixotropic behavior of the chabazite cake, i.e. lower moisture content led to lower thixotropic nature of the cake.

TABLE 4
Vacuum Filtration and cake wash experiments on Sample 3 using 10″
low frequency transducer in infrasound and audible range frequencies

| | | | | | | | | | | Estimated |
|---|---|---|---|---|---|---|---|---|---|---|
| | | | | Wash | Wash | | | | | Power |
| | | Cake | Cake | time | time | | | Distance | | received |
| | Cake | wash | wash | 1 diff to | 2 diff to | Wet | Input | to cake | | by the |
| Test | height | time | time | base case | base case | Cake | Power | surface | View | sample |
| No | (mm) | (s) | (s) | (%) | (%) | (g) | (W) | (mm) | factor | (W/cm²) |
| 24 | 9 | 68 | 66 | — | — | 72.5 | Base | — | — | — |
| | | | | | | | case | | | |
| 25 | 9 | 55 | 42 | −19% | −36% | 71.2 | 100 | 30 | 0.120 | 0.19 |
| 26 | 9 | 61 | 47 | −10% | −29% | 70.7 | 100 | 30 | 0.120 | 0.19 |

In addition to the geometry and shape of sonication device and filter device and their distance from each other, it was found that the sonication impact on the filtration, cake wash and/or cake deliquoring depends on properties of solids and/or liquid mixture such as solids particle size and solids particle shape. For example, in the tested samples, sonication was more effective on cake wash of sample 1 with mean particle size of 72 μm than sample 2 and 3 with 6 μm and 3 μm respectively. However, by changing the emitting power, frequency settings, sonication device geometry and setup, filter device geometry and setup and other physical and chemical intervention, the effectiveness of the sonication on wide range of solid-liquid compositions with different properties (e.g. smaller particle size, organic, inorganic, etc.) can be improved.

The present invention has been described with reference to specific exemplary embodiments thereof. The specification and drawings are, accordingly, to be regarded in an illustrative rather than a restrictive sense. Various modifications of the invention in addition to those shown and described herein will become apparent to those skilled in the art and are intended to fall within the scope of the appended claims.

For simplicity of explanation, the embodiments of the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

1. A method for filtration of a solid-liquid composition comprising:
providing a filter;
passing the solid-liquid composition through the filter to form a filter cake on the filter; and
sonicating the filter cake, the solid-liquid composition, or a combination thereof on the filter.

2. The method of claim 1, further comprising washing the filter cake with a wash liquor before performing the sonicating.

3. The method of claim 2, wherein the sonicating the filter cake and the washing the filter cake are performed at the same time.

4. The method of claim 1, further comprising deliquoring the filter cake with a gas.

5. The method of claim 1, further comprising mechanically squeezing the filter cake.

6. (canceled)

7. The method of claim 1, wherein the sonicating is performed using a sonication device.

8. The method of claim 7, wherein the sonication device comprises an audible device, an ultrasound device, a sound generator, an amplifier, a transducer device, or a combination thereof.

9. The method of claim 7, wherein the sonication device comprises an infrasound device.

10. (canceled)

11. (canceled)

12. The method of claim 9, wherein the infrasound device comprises a device that uses a frequency of less than about 20 Hz.

13. (canceled)

14. (canceled)

15. The method of claim 1, wherein the sonicating comprises sweeping frequencies for a time.

16. The method of claim 7, wherein the sonication device is at a distance of about 1 mm to 20 cm to a surface of the filter cake.

17. (canceled)

18. The method of claim 1, wherein the filter cake is sonicated for about 1 second to about 36 hours, either intermittently or continuously.

19. The method of claim 1, wherein the filter cake is sonicated at a power of about 0.01 W/cm² of the filer area to about 5 kW/cm² of the filter area.

20. The method of claim 1, wherein the filter cake is sonicated at a power of about 0.01 W/cm³ of filter cake volume to about 15 kW/cm³ of filter cake volume.

21. The method of claim 7, wherein the sonicating the filter cake is performed by having the sonication device in direct contact or indirect contact with the filter, or protruding into the filter cake.

22.-26. (canceled)

27. A filtration system for filtering a solid-liquid composition comprising:
a filtration device; and
a sonication device, wherein the sonication device is configured to contact or protrude into a filter cake.

28. (canceled)

29. The filtration system of claim 27, wherein the filtration device comprises a housing and a filter.

30. (canceled)

31. (canceled)

32. The filtration system of claim 27, wherein the sonication device comprises an audible sound device, ultrasound device, a sound transmission device, a sound generation device, an amplifier device, a transducer device, or an infrasound device.

33. (canceled)

34. The filtration system of claim 27, wherein the solid-liquid composition comprises a slurry, a filter cake or a thixotropic slurry.

35.-37. (canceled)

38. A method for filtering a solid-liquid composition including:
passing the solid-liquid composition through a filter to form a filter cake;
washing the filter cake with a wash liquor; and
sonicating the filter cake using a sonication device.

39.-50. (canceled)
